(19) United States
(12) Patent Application Publication
(10) Pub. No.: US 2006/0287414 A1
(43) Pub. Date: Dec. 21, 2006

(54) Acrylic plaster coating composition

(76) Inventor: Robin S. Knight, Albuquerque, NM (US)

Correspondence Address: PEACOCK MYERS, P.C., 201 THIRD STREET, N.W., SUITE 1340, ALBUQUERQUE, NM, 87102, US

(21) Appl. No.: 11/444,747

(22) Filed: May 31, 2006

Related U.S. Application Data
(60) Provisional application No. 60/685,914, filed on May 31, 2005.

(51) Int. Cl. C04B 24/26

(52) U.S. Cl. 524/5

(57) ABSTRACT

The present invention provides a translucent, acrylic based plaster composition, particularly for coating wall surfaces. The composition provides a mottled surface effect.

### CROSS-REFERENCES TO RELATED APPLICATIONS

This application claims the benefit of the filing of U.S. Provisional Patent Application Ser. No. 60/685,914, titled “Acrylic Plaster”, filed May 31, 2005, and the specification in that application is incorporated herein by reference.

### BACKGROUND OF THE INVENTION

1. Field of the Invention (Technical Field)

The present invention relates to acrylic based plaster finishes, particularly for application to wall surfaces.

2. Description of Related Art

Various wall finishes are known in the art including dry wall plaster and traditional gypsum, lime, and cement-based plaster. Traditional plaster is heavy and its use requires the application of several coatings or layers and a significant amount of drying time. Also, traditional plaster is subject to cracking, chipping, and flaking.

The present inventor has developed acrylic polymer based plaster finishes that provide for finishes of various textures and colors. The plasters may be applied to drywall, texture and paint, painted surfaces, traditional plaster, or any other substrate suitable for plaster application. The plasters require few coatings or layers, dry more quickly and weigh less than traditional plasters, and do not crack, chip, or flake. Yet additional formulations are desirable to provide for additional textures, colorations, and application techniques.

The present invention provides for a translucent plaster finish composition that results in a mottled effect similar to the appearance of Southwestern interior plasters and Venetian plasters.

### BRIEF SUMMARY OF THE INVENTION

Briefly stated, the present invention provides an acrylic based, plaster finish coating. One embodiment comprises a translucent plaster finish, and another embodiment comprises a sprayable plaster finish that is also preferably translucent.

Thus, an embodiment of the present invention comprises a plaster finish, surface coating composition comprising a primary liquid mixture comprising a first acrylic resin, a second, elastomeric, acrylic resin, a first particulate, and water, and a second particulate solid, a white pigment, and water. The coating composition may further comprise a color pigment. Preferably, the primary liquid mixture further comprises a a retarder to slow drying of said resins, a first defoamer to reduce aeration, a second defoamer, a thickener, a pH stabilizer, an anti-bacterial agent, a wetting agent, a first surfactant to help blend components, a second self-leveling surfactant, a third particulate solid, an activator, or a combination thereof. The first particulate preferably comprises marble, more preferably marble white 325. The primary liquid mixture may further comprise an acrylic polymer to enhance hardening of the plaster. The white pigment preferably comprises titanium dioxide, preferably in a concentration of from between approximately 0.25 and 0.75 percent by weight. The second particulate solid may comprise marble white 325 or a combination of marble white 325 and marble 50-200. The coating composition may further comprise a polyvinyl acetate and a thickener.

Preferably, the primary liquid mixture comprises the first acrylic resin in a concentration of from between approximately 10 and 25 percent by weight. Preferably, the primary liquid mixture comprises the second acrylic resin in a concentration of from between approximately 12 and 23 percent by weight. Preferably, the coating composition comprises the primary liquid mixture in a concentration of from between approximately 37 and 51 percent by weight. Preferably, the second particulate comprises marble, preferably in a concentration of from between approximately 42 and 56 percent by weight. Preferably, the coating composition comprises the acrylic polymer in a concentration of from between approximately 4 and 7 percent by weight.

Another embodiment of the present invention provides a liquid mixture for use in a plaster finish, surface coating composition, said liquid mixture comprising, a first acrylic resin, a second, elastomeric, acrylic resin, a particulate solid, a white pigment, and water.

Another embodiment of the present invention provides a method for creating a mottled plaster finish effect on a surface, said method comprising mixing a first acrylic resin, a second, elastomeric acrylic resin, a first particulate solid, and water to make a primary liquid mixture, mixing the primary liquid mixture with a second particulate solid, a color pigment, a white pigment, and water to make a surface coating composition, and applying the surface coating composition onto the surface. The method may further comprise applying an acrylic plaster finish primer on the surface prior to applying the surface coating composition. The method may further comprise adding an acrylic polymer to the primary liquid mixture. The method may further comprise applying the coating composition over the primer by spraying the coating composition. The method may further comprise burnishing the coating composition.

A primary object of the present invention is to provide plaster finishes that are easy to apply and that result in finishes of various textures and colorations comparable to traditional plasters that are more difficult and time consuming to apply.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawing, which is incorporated into, and forms a part of, the specification, illustrates an embodiment of the present invention and, together with the description, serves to explain the principles of the invention. The drawing is only for the purpose of illustrating an embodiment of the invention and is not to be construed as limiting the invention. In the drawing:

FIG. 1 is a perspective view of an embodiment of the plaster of the present invention disposed on a wall.

### DETAILED DESCRIPTION OF THE INVENTION

The present invention comprises a translucent, crack resistant, acrylic based composition for coating a surface, the composition also referred to herein as a plaster, acrylic plaster, plaster finish, or translucent plaster. The composition also comprises particulate solids. The plaster finish may be applied to a smooth finish by, for example, trowel, and the plaster may be tinted to any color. The translucent plaster finish mottles after it is applied which contributes to its texture and coloration effects. In one embodiment, the plaster finish may be applied by hand. In another embodiment, the plaster finish is sprayable so that it is applied by spraying onto a surface, and the sprayable embodiment is also capable of mottling. As used in the specification and claims herein, the terms “a”, “an”, and “the” mean one or more.

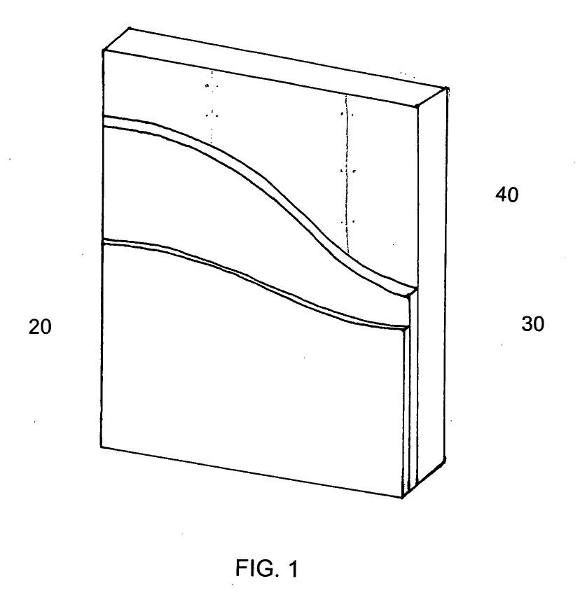

Thus, as shown in FIG. 1, translucent coating composition 20 of an embodiment of the present invention is applied over a commercially available plaster finish 30 that has been applied to a surface such as, but not limited to, wall 40. In one embodiment, plaster 20 is applied by hand, preferably by trowel. In another embodiment, plaster 20 is sprayed onto wall 40. In another embodiment, plaster finish 30 is not used.

In an embodiment of the present invention, the translucent plaster comprises: a primary or preliminary liquid mixture or component; a particulate solid such as, but not limited to, silica, quartz, and marble, preferably marble, more preferably marble white 325; and water, preferably water. Throughout the specification and claims, an aqueous medium, preferably water, is utilized for all mixtures and compositions. The particulate solid allows the plaster to be built up when applied and is intended to, preferably, give the appearance of a traditional lime or gypsum based plaster. In another embodiment wherein the plaster is sprayable, the plaster comprises: the primary liquid mixture; a marble particulate, preferably marble white #325; water; and an acrylic polymer that contributes to additional hardening, such as Armorez® IC-2959. These components are defined in more detail as follows.

The primary liquid mixture comprises a combination of at least a first acrylic resin and second acrylic resin. The first acrylic resin is preferably a standard acrylic resin and preferably exhibits one or more of the following characteristics: is crack resistant; is abrasion and scrub resistant; provides good to excellent adhesion to most surfaces; is moisture resistant; and is able to hold mineral particulates in suspension such that burnishing of a surface creating sheen is enabled. An example of such a first acrylic may comprise, but is not limited to, M-444 (from Specialty Polymers). The first acrylic resin is present in the liquid component in a concentration of preferably between approximately 10.00 and 25.00 percent by weight, and more preferably approximately 16.05 percent by weight.

The second acrylic resin is preferably an elastomeric acrylic resin and preferably exhibits one or more of the following characteristics: allows for greater crack resistance and can stretch over cracks; and holds particulates in suspension thus allowing for greater “build” (i.e., thickness) of the finish. An example of such a second acrylic resin may comprise, but is not limited to, SP L2023 (from Specialty Polymers), preferably in a concentration of between approximately 12.0 and 23.0 percent by weight, and more preferably approximately 18.00 percent by weight. The combination of the at least two acrylic resins provides a “mottling” effect in the coloration and shade of the final finish.

Without being limited to theory, the combination of the first and second acrylic resins provides for the desired qualities in performance, workability, and aesthetics. Both resins are easily tinted. The tint strength (the amount of colorant added to the plaster and required to achieve a given color) can be controlled by an appropriate amount of white pigment, such as, but not limited to, titanium dioxide. Lower amounts of titanium dioxide provide for a greater mottling effect.

Thus, the primary liquid mixture also comprises a pigment at a concentration to provide a translucent quality to the plaster. For example, a white pigment is added to make the formulation monochrome and opaque (i.e., translucent), preferably a titanium dioxide pigment such as, but not limited to, CR-50-2 TiO₂ (Tipaque®, by ISK), preferably in a concentration of between approximately 0.25 and 0.75 percent by weight, and more preferably approximately 0.50 percent by weight. As used herein, the term “white pigment” includes any pigment that is a variant of white, including, but not limited to, off-white pigment, approximately white pigment, substantially white pigment, etc.

The primary liquid mixture preferably further comprises the following:

(a) a retarder to slow down the drying of the resin, preferably propylene glycol, preferably at a concentration of approximately 2.00 percent by weight;

(b) a defoamer to eliminate or reduce aeration when mixing, preferably comprising hydrophobic solids and polysiloxanes such as BYK®-044 (from BYK Chemie), preferably at a concentration of approximately 0.15 percent by weight;

(c) a second defoamer, preferably a silicone defoamer comprising polysiloxanes and hydrophobic solids in polyglycol such as BYK®0018 (from BYK Chemie), preferably at a concentration of approximately 0.15 percent by weight;

(d) water, preferably at a concentration of approximately 18.95 percent by weight;

(e) a thickener for helping hold components, such as particulates and granules, in suspension, preferably Acrysol® ASE-60 (from Rohm and Haas), preferably at a concentration of approximately 2.30 percent by weight;

(f) a pH stabilizer, preferably aminomethyl propanol such as AMP-95®, (from Angus Chemical Co.), preferably at a concentration of approximately 0.55 percent by weight;

(g) an anti-bacterial agent, preferably 1-methyl-3,5,7-triaza-1-azoniatricyclo-decane chloride such as Busan® 1024 (from Buckman Laboratories), preferably at a concentration of approximately 0.10 percent by weight;

(h) a wetting agent to help retain moisture and aid in wetting out the components in the formulation, such as Superwet 22S (from Shepard Brothers), preferably at a concentration of approximately 0.05 percent by weight;

(i) a surfactant to help blend the components and to help the final formulation spread smoothly and easily when applied to a surface (this surfactant also functions as a thickener and aids in workability (i.e., the spreading of the finish under a trowel), such as Busperse®) 39 (from Buckman Laboratories), preferably at a concentration of approximately 0.20 percent by weight,

(j) a second surfactant, with self-leveling characteristics to keep the finish uniform in thickness while it is being applied, such as Busperse® 229 (from Buckman Laboratories), preferably at a concentration of approximately 0.15 percent by weight;

(k) a particulate solid, preferably a marble, preferably marble white 325, preferably at a concentration of approximately 39.50 percent by weight;

(l) an activator to enhance mixing and blending components in solution (and keeping them in solution) preferably ester alcohol, such as Texanol (from Eastman Coatings), preferably in a concentration of approximately 1.0 percent by weight; or (m) a combination thereof.

In all embodiments, the particulate solid present in the primary liquid mixture preferably comprises marble, preferably marble white 325. Marble white 325 is a dry ground marble with a particle size of 325 mesh (i.e., 0.044 mm). The acrylic polymer used to contribute to additional hardening of the finish when the finish dries preferably comprises a highly efficient efflorescence sealer, preferably Armorez® IC-2959 (from Mead Westvaco).

The final surface coating composition preferably comprises between approximately 38.0 and 51.0 percent by weight of the primary liquid mixture, more preferably between approximately 42.0 and 46.0 percent by weight of the primary liquid component, and most preferably approximately 45.36 percent by weight of the primary liquid component. The coating composition also preferably comprises between approximately 43.0 and 56.0 percent by weight marble white 325, more preferably between approximately 46.0 and 50.0 percent by weight marble white 325, and most preferably approximately 49.92 percent by weight marble white 325. The coating composition also preferably comprises between approximately 4.0 and 13.0 percent by weight water, more preferably between approximately 4.7 and 6.0 percent by weight water, and most preferably approximately 4.72 percent by weight water.

To provide for a higher degree of build-up (in other words, thicker coats) of the coating composition, the second particulate solid preferably comprises a combination of marble white 325 and marble 50-200 (a dry ground marble with a coarse particle size controlled between 50 and 200 mesh screens). Preferably, when adding that marble combination, a polyvinyl (preferably Raybond® D-232, from Specialty Polymer Products) and a thickener (such as Bernocol CST 349) are added to the final composition.

The sprayable embodiment of the surface coating composition preferably comprises between approximately 37.0 and 48.0 percent by weight of the primary liquid component, more preferably between approximately 40.0 and 44.0 percent by weight of the primary liquid component, and most preferably approximately 43.28 percent by weight of the primary liquid component. The sprayable composition also preferably comprises between approximately 42.0 and 52.0 percent by weight marble white 325, more preferably between approximately 44.0 and 48.0 percent by weight marble white 325, and most preferably approximately 47.76 percent by weight marble white 325. The sprayable composition also preferably comprises between approximately 4.0 and 11.0 percent by weight water, more preferably between approximately 4.3 and 5.0 percent by weight water, and most preferably approximately 4.48 percent by weight water. The sprayable composition also preferably comprises between approximately 4.0 and 7.0 percent by weight Armorez® IC2959, more preferably between approximately 4.2 and 6.0 percent by weight Armorez® IC-2959, and most preferably approximately 4.48 percent by weight Armorez® IC-2959.

The coating composition of the present invention does not cure, it dries. Therefore, its progress to a hard finish is steady and predictable, and very forgiving. For example, a “cold joint” can be left in a wall, and it will not show through the finish.

The present invention allows for burnishing, even after the plaster is dry. Therefore, the plaster of the present invention can be trowelled until smooth. Without being bound by theory, this attribute is provided via the use of marble in the formulation. The use of acrylics alone do not allow for burnishing as they “burn” or “tarnish” when trowelled.

The present invention provides for a mottle color and shading feature. The present invention allows for work to be performed on the finish over time. For example, the finish can be re-worked even after drying for a period of time, such as a day, by applying more of the surface coating composition or using a sanding sponge with water. Therefore, imperfections in the finish can be cured.

The surface coating composition can be applied directly on a surface, such as a wall. The various, desired finish appearances are easily accomplished in embodiments wherein the surface is first primed with a tinted, opaque plaster finish or a non-textured primer, both described below. Using the opaque plaster finish, a finish typically associated with interior plasters found in the Southwest United States is accomplished. Because the coating composition described herein is translucent, it allows some of the color of the opaque plaster finish to show thorough, leaving a subtle mottling effect, particularly if the coating composition is tinted in a color slightly different from that of the opaque plaster finish. Using the non-textured primer, an appearance of Venetian-type plasters is achieved.

The opaque plaster finish preferably comprises:

(a) a preliminary liquid component, preferably in a concentration of approximately 42 to 45.5 percent by weight, comprising (all percentages are by weight): M-444, propylene glycol, Polyphase® 600, BYK®-044, Acrysol® ASE-60, AMP-95®), Busan® 1024, Superwet 22S, Busperse® 39, TiO₂, Busperse® 229, marble white 325, and BYK®-018;

(b) Marble white 325, preferably in a concentration of approximately 46.5 to 50.0 percent by weight; and

(c) water, preferably in a concentration of approximately 4.5 to 10.0 percent by weight.

The non-textured primer preferably comprises water, marble white 325, KTPP powder (potassium tri poly phosphate; from Pigmentan Co.), Texanol, Polyphase® 600 (a transparent, water dispersible liquid, non-metallic preservative for control of fungi and yeast in water based adhesives (glues), paints, water and tempera colors, inks, pigment slurries, clays and photographic emulsions; from Troy Corp.), BYK®-018, Bermocoll® CST 349 (ethyl hydroxyethyl cellulose; from Akzo Nobel Surface Chemistry), AMP-95®, Busperse® 39, TiO₂, Glomax LL (calcined, fractionated kaolin with extremely low grit and controlled particle size; from DBK Functional Pigments), Busan® 1024, Armorez® IC-2959, M-444, Superwet 22S, ASE-60, and PUR 2110 (from Akzo Nobel).

### INDUSTRIAL APPLICABILITY

A plaster finish using the translucent coating composition in accordance with the present invention is accomplished by the following, non-limiting examples (all percentages are by weight):

### EXAMPLE 1

The primary liquid mixture of the coating composition is made taking the following steps:

(1) approximately 18.00 percent SP L2023 resin, 1.00 percent propylene glycol, 0.15 percent BYK®-044, and water are mixed to form a first pre-mixture;

(2) approximately 0.5 percent water, 1.00 percent Acrysol® ASE-60, 0.20 AMP-95®, 0.10 percent Busan® 1024, 0.05 percent Superwet 22S, 0.20 percent Busperse® 39, 0.50 percent TiO₂, and 5.00 percent water are added and mixed for approximately 5 minutes;

(3) approximately 16.05 percent M-444, 0.15 percent Busperse® 229, 39.50 marble white 325, 4.30 percent water, and 0.15 percent BYK®-018 are added and mixed; and

(4) approximately 1.50 percent water, 1.30 percent Acrysol® ASE-60, 0.35 percent AMP-95®, 1.00 percent propylene glycol, and 1.00 percent Texanol are added and mixed.

### EXAMPLE 2

A plaster finish using the translucent plaster in accordance with the present invention is applied on a wall as follows:

1) a smooth, non-textured, acrylic-based primer described above is made comprising:
approximately 44.56 percent water;
approximately 0.04 percent KTPP powder (potassium tri poly phosphate; from Pigmentan Co.);
approximately 1.50 percent Texanol;
approximately 0.08 percent Polyphase® 600 (a transparent, water dispersible liquid, non-metallic preservative for control of fungi and yeast in water based adhesives (glues), paints, water and tempera colors, inks, pigment slurries, clays and photographic emulsions; from Troy Corp.);
approximately 0.40 percent BYK®-018;

approximately 0.60 percent Bermocoll® CST 349 (ethyl hydroxyethyl cellulose; from Akzo Nobel Surface Chemistry);
approximately 0.04 percent AMP-95®,
approximately 0.30 percent Busperse® 39;
approximately 7.30 percent CR-50-2 (TiO₂);
approximately 1.00 percent Glomax LL (calcined, fractionated kaolin with extremely low grit and controlled particle size; from DBK Functional Pigments);
approximately 20.00 percent marble white 325;
approximately 0.08 percent Busan® 1024;
approximately 5.00 percent IC-2959;
approximately 17.00 percent M-444;
approximately 0.10 percent Superwet 22S;
approximately 0.80 percent Acrysol® ASE-60; and
approximately 0.20 percent PUR 2110 (from Akzo Nobel);

2) the non-textured primer is applied to the wall;

3) at least two coats of the translucent plaster of the present invention (having a color tint similar to the primer) are applied over the primer in random/decorative strokes—the first coat may be water trowelled (i.e., spraying a fine mist of water over the coating then trowelling), and the subsequent coat(s) are applied as thinly as possible and preferably before the first coat has fully dried;

4) the finish is allowed to mottle, creating a finish similar to Venetian and lime plaster finishes;

5) if desired, the finish can be burnished with a Venetian trowel or burnishing blade after the finish has dried; and

6) if desired, a sealer or wax may be applied to the finish.

### EXAMPLE 3

A plaster finish using the translucent plaster in accordance with the present invention is applied on a wall as described in Example 2, except that the non-textured primer is not used.

### EXAMPLE 4

A plaster finish using the translucent plaster primer in accordance with the present invention is applied on a wall as follows:

1) an opaque acrylic plaster finish described above is made comprising:
a. approximately 45.37 percent of a primary liquid component comprising:
   approximately 34.05 percent M-444;
   approximately 3.00 percent Propylene glycol;
   approximately 0.10 percent Polyphase® 600;
   approximately 0.05 percent BYK®-044;
   approximately 12.80 percent water;
   approximately 1.20 percent Acrysol® ASE-60;
   approximately 0.15 percent AMP-95®;
   approximately 0.10 percent Busan® 1024;
   approximately 0.05 percent Superwet 22S;
   approximately 0.40 percent Busperse® 39;
   approximately 5.10 percent CR-50-2 TiO₂;
   approximately 0.10 percent Busperse® 229;
   approximately 38.00 percent marble white 325; and
   approximately 0.10 percent BYK®-018;
b. approximately 49.91 percent marble white 325, and
c. approximately 4.72 percent water;

2) the opaque plaster finish is trowelled onto the wall in a relatively random manner in a thickness of 1/16 of an inch or less, allowed to dry for approximately 15 minutes, then water trowelled;

3) after the opaque plaster finish is dry (after approximately 1-2 hours) at least one, much thinner coat of the translucent surface coating plaster composition of the present invention is applied over the opaque plaster;

4) the finish can then be burnished approximately 15 minutes later if desired using a dry trowel or burnishing blade, with the resulting finish having the appearance of traditional interior plaster found in, and associated with, the Southwestern United States; and

5) if a richer appearance is desired, a sealer or wax may be applied after the finish has dried for at least approximately 12 hours.

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above are hereby incorporated by reference.

What is claimed is:

1. A plaster finish, surface coating composition comprising:
a primary liquid mixture comprising:
a first acrylic resin;
a second, elastomeric, acrylic resin;
a first particulate solid;
a white pigment; and
water; and
a second particulate solid; and
water.

2. The coating composition of claim 1 further comprising a color pigment.

3. The coating composition of claim 1 wherein said primary liquid mixture further comprises a component selected from the group consisting of a retarder to slow drying of said resins, a first defoamer to reduce aeration, a second defoamer, a thickener, a pH stabilizer, an anti-bacterial agent, a wetting agent, a first surfactant to help blend components, a second self-leveling surfactant, a third particulate solid, an activator, and a combination thereof.

4. The coating composition of claim 1 wherein said first particulate comprises marble.

5. The coating composition of claim 1 wherein said first particulate solid comprises marble white 325.

6. The coating composition of claim 1 wherein said primary liquid mixture further comprises an acrylic polymer to enhance hardening of said plaster.

7. The coating composition of claim 1 wherein said white pigment comprises titanium dioxide.

8. The coating composition of claim 1 wherein said primary liquid mixture comprises said white pigment in a concentration of from between approximately 0.25 and 0.75 percent by weight.

9. The coating composition of claim 1 wherein said primary liquid mixture comprises said first acrylic resin in a concentration of from between approximately 10 and 25 percent by weight.

10. The coating composition of claim 1 wherein said primary liquid mixture comprises said second acrylic resin in a concentration of from between approximately 12 and 23 percent by weight.

11. The coating composition of claim 1 comprising said primary liquid mixture in a concentration of from between approximately 37 and 51 percent by weight.

12. The coating composition of claim 1 wherein said second particulate solid comprises marble.

13. The coating composition of claim 12 wherein said marble is present in a concentration of from between approximately 42 and 56 percent by weight.

14. The coating composition of claim 5 wherein said acrylic polymer is present in a concentration of from between approximately 4 and 7 percent by weight.

15. The coating composition of claim 1 wherein said second particulate solid comprises marble white 325.

16. The coating composition of claim 1 wherein said second particulate solid comprises marble white 325 and marble 50-200.

17. The coating composition of claim 16 further comprising a polyvinyl acetate and a thickener.

18. A liquid mixture for use in a plaster finish, surface coating composition, said liquid mixture comprising:
a first acrylic resin;
a second, elastomeric, acrylic resin;
a particulate solid;
a white pigment; and
water.

19. A method for creating a mottled plaster finish effect on a surface, said method comprising:
mixing a first acrylic resin, a second, elastomeric acrylic resin, a first particulate solid, and water to make a primary liquid mixture;
mixing the primary liquid mixture with a second particulate solid, a color pigment, a white pigment, and water to make a surface coating composition; and
applying the surface coating composition onto the surface.

20. The method of claim 19 further comprising applying an acrylic plaster finish primer on the surface prior to applying the surface coating composition.

21. The method of claim 19 further comprising adding an acrylic polymer to the primary liquid mixture.

22. The method of claim 19 wherein applying the coating composition over the primer comprises spraying the coating composition.

23. The method of claim 19 further comprising burnishing the coating composition.
